(19) United States
(12) Patent Application Publication
(10) Pub. No.: US 2022/0188853 A1
(43) Pub. Date: Jun. 16, 2022

(54) CONTROL APPARATUS AND FEE DETERMINATION METHOD

(71) Applicant: TOYOTA JIDOSHA KABUSHIKI KAISHA, Toyota-shi (JP)

(72) Inventors: Toyokazu NAKASHIMA, Nagoya-shi (JP); Shunsuke SAGARA, Nisshin-shi (JP); Naoya OKA, Nagakute-shi (JP)

(73) Assignee: TOYOTA JIDOSHA KABUSHIKI KAISHA, Toyota-shi (JP)

(21) Appl. No.: 17/548,262

(22) Filed: Dec. 10, 2021

(30) Foreign Application Priority Data
Dec. 11, 2020 (JP) 2020-206348

(51) Int. Cl. G06Q 30/02; G06V 20/54

(52) U.S. Cl. CPC G06Q 30/0206; G06V 2201/08; G06V 20/54

(57) ABSTRACT

A control apparatus includes a controller configured to detect a vehicle parked on a road at a first time point, and determine an amount of a parking fee to be charged to the vehicle according to a traffic congestion condition on the road at a second time point that is same as or later than the first time point.

### CROSS-REFERENCE TO RELATED APPLICATION

This application claims priority to Japanese Patent Application No. 2020-206348, filed on Dec. 11, 2020, the entire contents of which are incorporated herein by reference.

### TECHNICAL FIELD

The present disclosure relates to a control apparatus and a fee determination method.

### BACKGROUND

Patent Literature (PTL) 1 discloses an apparatus that predicts the number of vehicles exiting from a parking lot and the amount of traffic on roads surrounding the parking lot after a certain period of time, and when the vehicles exiting from the parking lot adversely affect the surrounding roads, changes distribution of the number of exiting vehicles at each exit or controls timing of vehicles exiting at each exit.

### CITATION LIST

### Patent Literature

PTL 1: JP H07-200995 A

### SUMMARY

Parking-related traffic congestion includes, besides traffic congestion on roads surrounding parking lots, traffic congestion caused by on-street parking.

It would be helpful to facilitate reduction of traffic congestion caused by on-street parking.

A control apparatus according to the present disclosure includes a controller configured to:

detect a vehicle parked on a road at a first time point; and

determine an amount of a parking fee to be charged to the vehicle according to a traffic congestion condition on the road at a second time point that is same as or later than the first time point.

A fee determination method according to the present disclosure includes:

detecting, by a control apparatus, a vehicle parked on a road at a first time point; and

determining, by the control apparatus, an amount of a parking fee to be charged to the vehicle according to a traffic congestion condition on the road at a second time point that is same as or later than the first time point.

According to the present disclosure, it is possible to facilitate reduction of traffic congestion caused by on-street parking.

### BRIEF DESCRIPTION OF THE DRAWINGS

In the accompanying drawings:

FIG. 1 is a diagram illustrating a configuration of a system according to an embodiment of the present disclosure;

FIG. 2 is a block diagram illustrating a configuration of a control apparatus according to the embodiment of the present disclosure;

FIG. 3 is a flowchart illustrating operations of the control apparatus according to the embodiment of the present disclosure;

FIG. 4 is a flowchart illustrating operations of the control apparatus according to the embodiment of the present disclosure; and

FIG. 5 is a flowchart illustrating operations of the control apparatus according to a variation of the embodiment of the present disclosure.

### DETAILED DESCRIPTION

An embodiment of the present disclosure will be described below, with reference to the drawings.

In the drawings, the same or corresponding portions are denoted by the same reference numerals. In the descriptions of the present embodiment, detailed descriptions of the same or corresponding portions are omitted or simplified, as appropriate.

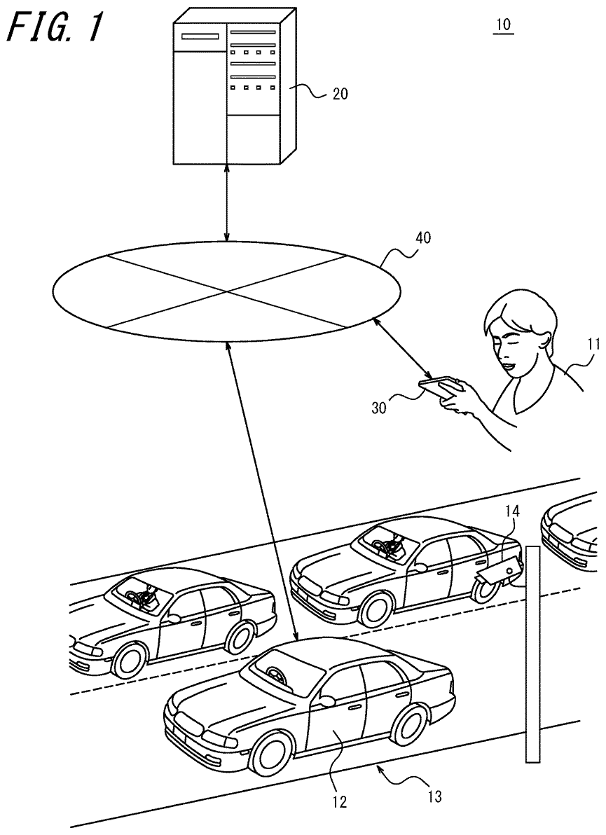

A configuration of a system 10 according to the present embodiment will be described with reference to FIG. 1.

The system 10 according to the present embodiment includes at least one control apparatus 20, and at least one terminal apparatus 30. The control apparatus 20 can communicate with the terminal apparatus 30 via a network 40.

The control apparatus 20 is installed in a facility such as a data center. The control apparatus 20 is a computer such as a server that belongs to a cloud computing system or another type of computing system.

The terminal apparatus 30 is held by a user 11 and used by the user 11. The terminal apparatus 30 is, for example, a mobile device such as a mobile phone, a smartphone, or a tablet.

The network 40 includes the Internet, at least one WAN, at least one MAN, or any combination thereof. The term “WAN” is an abbreviation of wide area network. The term “MAN” is an abbreviation of metropolitan area network. The network 40 may include at least one wireless network, at least one optical network, or any combination thereof. The wireless network is, for example, an ad hoc network, a cellular network, a wireless LAN, a satellite communication network, or a terrestrial microwave network. The term “LAN” is an abbreviation of local area network.

An outline of the present embodiment will be described with reference to FIG. 1.

The control apparatus 20 detects a vehicle 12 parked on a road 13 at a first time point T1. The control apparatus 20 determines the amount of a parking fee to be charged to the vehicle 12 according to a traffic congestion condition on the road 13 at a second time point T2 that is the same as or later than the first time point T1. Therefore, according to the present embodiment, it is possible to facilitate reduction of traffic congestion caused by on-street parking.

The vehicle 12 is, for example, any type of automobile such as a gasoline vehicle, a diesel vehicle, an HEV, a PHEV, a BEV, or an FCEV. The term “HEV” is an abbreviation of hybrid electric vehicle. The term “PHEV” is an abbreviation of plug-in hybrid electric vehicle. The term “BEV” is an abbreviation of battery electric vehicle. The term “FCEV” is an abbreviation of fuel cell electric vehicle. The vehicle 12 is driven by a driver in the present embodiment, but the driving may be automated at any level. The automation level is, for example, any one of Level 1 to Level 5 according to the level classification defined by SAE. The name “SAE” is an abbreviation of Society of Automotive Engineers.

The vehicle 12 may be parked at a location on the road 13 where there is a border, a parking meter, or both, but in the present embodiment, the vehicle 12 is parked at a location on the road 13 where there is neither a border nor a parking meter. The parking fee may be a parking price to be charged in exchange for a parking service, or a fine to be imposed for parking in a no parking area.

As the method for detecting the vehicle 12, any method may be used, but in the present embodiment, a method is used in which a position of the vehicle 12 measured by a GNSS receiver mounted in the vehicle 12 is checked to determine whether the vehicle 12 is parked on the road 13. The term “GNSS” is an abbreviation of global navigation satellite system. GNSS is, for example, GPS, QZSS, BDS, GLONASS, or Galileo. The term “GPS” is an abbreviation of Global Positioning System. The term “QZSS” is an abbreviation of Quasi-Zenith Satellite System. QZSS satellites are called quasi-zenith satellites. The term “BDS” is an abbreviation of BeiDou Navigation Satellite System. The term “GLONASS” is an abbreviation of Global Navigation Satellite System. As an alternative method, a method may be used in which an image captured by a camera 14 installed in the vicinity of the road 13 is analyzed to determine whether the vehicle 12 is parked on the road 13. As the image analysis method, a known method can be used. Machine learning, such as deep learning, may be used.

In the present embodiment, the control apparatus 20 executes charging processing for the parking fee with the determined amount. As the charging processing method, any method can be used. For example, a method can be used in which the parking fee is charged to a credit card or a bank account registered in advance in association with the user 11. The control apparatus 20 may notify the user 11 of a result of the charging processing via the terminal apparatus 30. The user 11 may be a person who has parked the vehicle 12, such as a driver, or may be an owner of the vehicle 12.

As a variation of the present embodiment, instead of executing the charging processing, the control apparatus 20 may simply notify the user 11 of the determined amount via the terminal apparatus 30. In such a variation, the user 11 may operate the terminal apparatus 30 to pay the notified amount by online payment or electronic money payment.

As a variation of the present embodiment, in a case in which the vehicle 12 has been parked since before traffic congestion occurs, the control apparatus 20 may notify the user 11 of an alert, raise the upper limit of the parking fee, or collect an additional fee via the terminal apparatus 30.

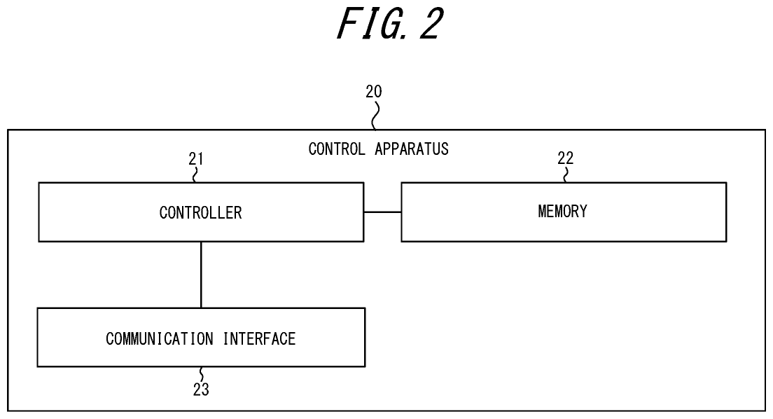

A configuration of the control apparatus 20 according to the present embodiment will be described with reference to FIG. 2.

The control apparatus 20 includes a controller 21, a memory 22, and a communication interface 23.

The controller 21 includes at least one processor, at least one programmable circuit, at least one dedicated circuit, or any combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The programmable circuit is, for example, an FPGA. The term “FPGA” is an abbreviation of field-programmable gate array. The dedicated circuit is, for example, an ASIC. The term “ASIC” is an abbreviation of application specific integrated circuit. The controller 21 executes processes related to operations of the control apparatus 20 while controlling components of the control apparatus 20.

The memory 22 includes at least one semiconductor memory, at least one magnetic memory, at least one optical memory, or any combination thereof. The semiconductor memory is, for example, RAM or ROM. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The memory 22 functions as, for example, a main memory, an auxiliary memory, or a cache memory. The memory 22 stores data to be used for the operations of the control apparatus 20 and data obtained by the operations of the control apparatus 20.

The communication interface 23 includes at least one interface for communication. The interface for communication is, for example, a LAN interface. The communication interface 23 receives data to be used for the operations of the control apparatus 20, and transmits data obtained by the operations of the control apparatus 20.

The functions of the control apparatus 20 are realized by execution of a program according to the present embodiment by a processor serving as the controller 21. That is, the functions of the control apparatus 20 are realized by software. The program causes a computer to execute the operations of the control apparatus 20, thereby causing the computer to function as the control apparatus 20. That is, the computer executes the operations of the control apparatus 20 in accordance with the program to thereby function as the control apparatus 20.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM on which the program is stored. The term “SD” is an abbreviation of Secure Digital. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, a program stored in a portable medium or a program transferred from a server. Then, the computer reads the program stored in the main memory using a processor, and executes processes in accordance with the read program using the processor. The computer may read a program directly from the portable medium, and execute processes in accordance with the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. Programs encompass information that is to be used for processing by an electronic computer and is thus equivalent to a program. For example, data that is not a direct command to a computer but has a property that regulates processing of the computer is “equivalent to a program” in this context.

Some or all of the functions of the control apparatus 20 may be realized by a programmable circuit or a dedicated circuit serving as the controller 21. That is, some or all of the functions of the control apparatus 20 may be realized by hardware.

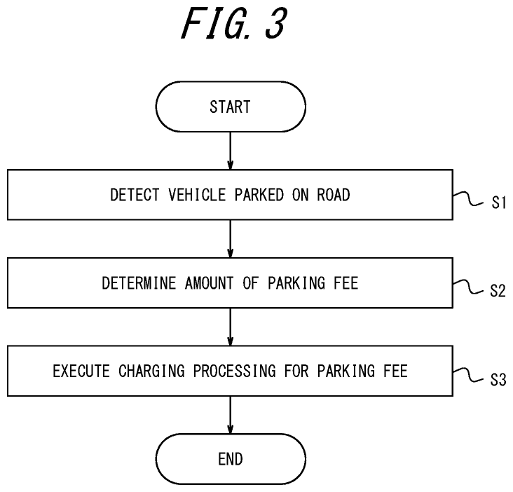

Operations of the control apparatus 20 according to the present embodiment will be described with reference to FIG. 3. These operations correspond to a fee determination method according to the present embodiment.

In step S1, the controller 21 of the control apparatus 20 detects a vehicle 12 parked on a road 13 at a first time point T1. In step S2, the controller 21 determines the amount of a parking fee to be charged to the vehicle 12 according to a traffic congestion condition on the road 13 at a second time point T2 that is the same as or later than the first time point T1. In step S3, the controller 21 executes charging processing for the parking fee with the determined amount.

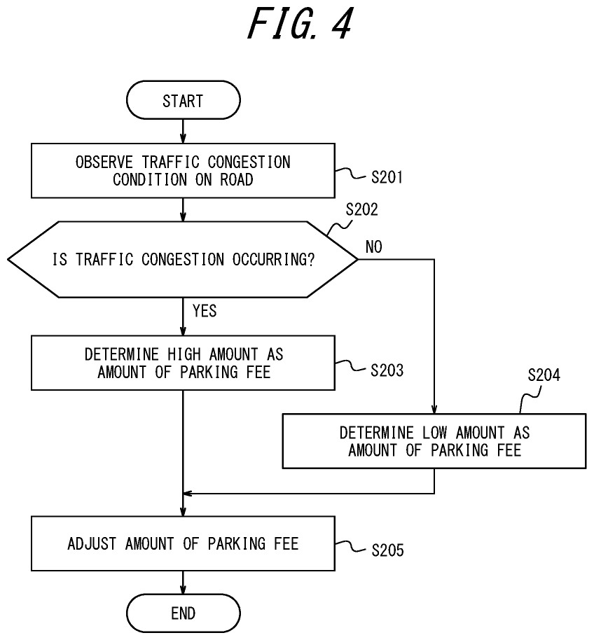

The details of the process in step S2 will be described with reference to FIG. 4.

In step S201, the controller 21 of the control apparatus 20 observes the traffic congestion condition at the second time point T2. The second time point T2 is the same point in time as the first time point T1. That is, when the vehicle 12 is currently parked, the controller 21 observes a current traffic congestion condition. This process may be executed in any procedure, but in the present embodiment, is executed in the following procedure.

The communication interface 23 of the control apparatus 20 receives an image that is captured at the second time point T2 by a camera 14 installed in the vicinity of the road 13 from the camera 14 or an external system such as a system that manages the camera 14. The controller 21 of the control apparatus 20 acquires the image received by the communication interface 23. The controller 21 observes the traffic congestion condition at the second time point T2 by analyzing the acquired image. As the image analysis method, a known method can be used. Machine learning, such as deep learning, may be used.

In step S202, the controller 21 of the control apparatus 20 refers to observation data obtained by observing the traffic congestion condition at the second time point T2. In the present embodiment, the observation data includes an image analysis result obtained in step S201. In a case in which the observation data indicates that traffic congestion is occurring on the road 13 at the second time point T2, the process in step S203 is executed. In a case in which the observation data indicates that no traffic congestion is occurring on the road 13 at the second time point T2, the process in step S204 is executed. An assessment of whether traffic congestion is occurring is made, for example, using a known indicator such as the number of vehicles or an occupancy rate.

In step S203, the controller 21 of the control apparatus 20 determines a relatively high amount as the amount of the parking fee. For example, the controller 21 may determine a fixed amount as the amount of the parking fee, or may determine, as the amount of the parking fee, a higher amount as the degree of traffic congestion indicated by the observation data increases. An assessment of the degree of traffic congestion is made, for example, using a known indicator such as the number of vehicles or an occupancy rate.

In step S204, the controller 21 of the control apparatus 20 determines a relatively low amount as the amount of the parking fee. This amount may be any amount, as long as the amount is lower than the amount determined in step S203. The controller 21 may determine to charge no parking fee.

In step S205, in a case in which the road 13 has left-hand traffic, the controller 21 of the control apparatus 20 estimates a tendency for occurrence of traffic congestion on the road 13 due to a left turn queue. Alternatively, in a case in which the road 13 has right-hand traffic, the controller 21 estimates a tendency for occurrence of traffic congestion on the road 13 due to a right turn queue. As the tendency estimation method, any method can be used. For example, a method can be used that determines which day of week and what time of day the tendency for occurrence of traffic congestion due to a left turn queue or a right turn queue is strong, with reference to past observation data obtained by a same process as that in step S201. The controller 21 adjusts the amount determined in step S203 or S204, depending on the strength of the estimated tendency. For example, the controller 21 may add a fixed amount to the amount of the parking fee in a case in which the tendency is stronger than a standard, or may add a higher amount to the amount of the parking fee as the tendency increases.

As a variation of the present embodiment, the amount of the parking fee may be adjusted depending on the lane count of the road 13, instead of or along with the strength of the tendency for occurrence of traffic congestion due to a left turn queue or a right turn queue. In such a variation, the controller 21 of the control apparatus 20 identifies the lane count of the road 13 with reference to map data. The map data is data defining, besides the location of the road 13, attributes such as the lane count of the road 13 and the direction of each lane. The map data may be stored in advance in the memory 22 of the control apparatus 20, or may be accumulated in an external system such as an Internet-based GIS. The term “GIS” is an abbreviation of geographic information system. The controller 21 adjusts the amount of the parking fee depending on the identified lane count. For example, the controller 21 may add a fixed amount to the amount of the parking fee in a case in which the lane count is less than a standard, or may add a higher amount to the amount of the parking fee as the lane count decreases.

As described above, in the present embodiment, the controller 21 of the control apparatus 20 detects a vehicle 12 parked on a road 13 at a first time point T1. The controller 21 determines the amount of a parking fee to be charged to the vehicle 12 according to a traffic congestion condition on the road 13 at a second time point T2 that is the same as or later than the first time point T1. Therefore, according to the present embodiment, it is possible to facilitate reduction of traffic congestion caused by on-street parking.

In the present embodiment, the controller 21 of the control apparatus 20 determines, as the amount of the parking fee, a higher amount in a case in which the observation data indicates that traffic congestion is occurring on the road 13 at the second time point T2 than in a case in which the observation data indicates that no traffic congestion is occurring on the road 13 at the second time point T2. In a case in which traffic congestion is occurring on the road 13, the presence of a parked vehicle on the road 13 may worsen the traffic congestion, but according to the present embodiment, it is possible to facilitate preventing the traffic congestion from worsening.

In the present embodiment, in a case in which the road 13 has left-hand traffic, the controller 21 of the control apparatus 20 adjusts the amount of the parking fee depending on the strength of the tendency for occurrence of traffic congestion on the road 13 due to a left turn queue. In a case in which traffic congestion tends to occur on the road 13 due to a left turn queue, the presence of a parked vehicle on the left edge of the road 13 may cause or worsen such traffic congestion, but according to the present embodiment, it is possible to facilitate preventing such traffic congestion from occurring or worsening.

In the present embodiment, in a case in which the road 13 has right-hand traffic, the controller 21 of the control apparatus 20 adjusts the amount of the parking fee depending on the strength of the tendency for occurrence of traffic congestion on the road 13 due to a right turn queue. In a case in which traffic congestion tends to occur on the road 13 due to a right turn queue, the presence of a parked vehicle on the right edge of the road 13 may cause or worsen such traffic congestion, but according to the present embodiment, it is possible to facilitate preventing such traffic congestion from occurring or worsening.

As a variation of the present embodiment, the controller 21 of the control apparatus 20 may adjust the amount of the parking fee depending on the lane count of the road 13. In a case in which the lane count of the road 13 is low, the presence of a parked vehicle on the road 13 may cause or worsen traffic congestion, but according to this variation, it is possible to facilitate preventing traffic congestion from occurring or worsening.

In the present embodiment, the controller 21 of the control apparatus 20 observes the traffic congestion condition at the second time point T2, but as a variation of the present embodiment, the controller 21 may acquire, from an external system, observation data obtained by observing the traffic congestion condition at the second time point T2 by the external system. That is, the process in step S201 may be omitted.

In the present embodiment, the second time point T2 is the same point in time as the first time point T1, but as a variation of the present embodiment, the second time point T2 may be a later point in time than the first time point T1. For example, the second time point T2 may be a point in time that is ten minutes, thirty minutes, or one hour after the first time point T1. Such a variation will be described.

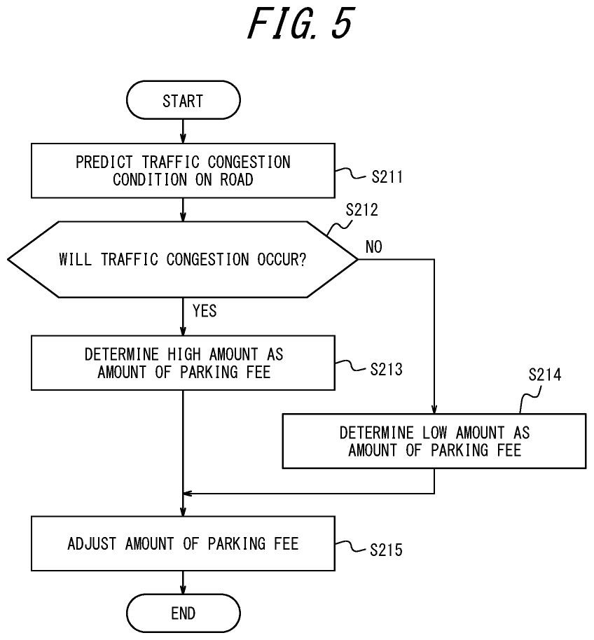

The details of the process in step S2 according to this variation will be described with reference to FIG. 5.

In step S211, the controller 21 of the control apparatus 20 predicts the traffic congestion condition at the second time point T2. That is, when the vehicle 12 is currently parked, the controller 21 predicts a future traffic congestion condition. This process may be executed in any procedure, but in the present embodiment, is executed in the following procedure.

The controller 21 of the control apparatus 20 acquires images that have been captured at and prior to the first time point T1 by a camera 14 installed in the vicinity of the road 13. The images may be stored in advance in the memory 22 of the control apparatus 20, or may be accumulated in an external system such as a system that manages the camera 14. The controller 21 estimates a tendency for occurrence of traffic congestion on the road 13 by analyzing the acquired images. As the image analysis method, a known method can be used. Machine learning, such as deep learning, may be used. As the tendency estimation method, any method can be used. For example, a method can be used that determines which day of week and what time of day the tendency for occurrence of traffic congestion is strong, with reference to an image analysis result. The controller 21 predicts the traffic congestion condition at the second time point T2 with reference to a tendency estimation result corresponding to the second time point T2. For example, in a case in which the tendency for occurrence of traffic congestion is estimated to be strong on the same day of week and at the same time of day as the second time point T2, the controller 21 predicts traffic congestion to occur on the road 13 at the second time point T2. In a case in which the tendency for occurrence of traffic congestion is estimated to be weak on the same day of week and at the same time of day as the second time point T2, the controller 21 predicts no traffic congestion to occur on the road 13 at the second time point T2.

In step S212, the controller 21 of the control apparatus 20 refers to a prediction result obtained in step S211. In a case in which traffic congestion is predicted to occur on the road 13 at the second time point T2, the process in step S213 is executed. In a case in which no traffic congestion is predicted to occur on the road 13 at the second time point T2, the process in step S214 is executed.

The processes in steps S213, S214, and S215 are the same as the processes in steps S203, S204, and S205, respectively, and thus descriptions thereof are omitted. For example, in step S213, the controller 21 of the control apparatus 20 may determine a fixed amount as the amount of the parking fee, or may determine, as the amount of the parking fee, a higher amount as the degree of predicted traffic congestion increases.

In this variation, the controller 21 of the control apparatus 20 determines, as the amount of the parking fee, a higher amount in a case in which traffic congestion is predicted to occur on the road 13 at the second time point T2 than in a case in which no traffic congestion is predicted to occur on the road 13 at the second time point T2. In a case in which traffic congestion is likely to occur on the road 13, the presence of a parked vehicle on the road 13 may cause heavier traffic congestion, but according to the present embodiment, it is possible to facilitate preventing such traffic congestion from occurring.

The present disclosure is not limited to the embodiment described above. For example, two or more blocks described in the block diagram may be integrated, or a block may be divided. Instead of executing two or more steps described in the flowcharts in chronological order in accordance with the description, the steps may be executed in parallel or in a different order according to the processing capability of the apparatus that executes each step, or as required. Other modifications can be made without departing from the spirit of the present disclosure.

For example, the process in step S205 may be omitted. The process in step S215 may be omitted.

1. A control apparatus comprising a controller configured to:
detect a vehicle parked on a road at a first time point; and
determine an amount of a parking fee to be charged to the vehicle according to a traffic congestion condition on the road at a second time point that is same as or later than the first time point.

2. The control apparatus according to claim 1, wherein
the second time point is a same point in time as the first time point, and
the controller is configured to refer to observation data obtained by observing the traffic congestion condition at the second time point.

3. The control apparatus according to claim 2, wherein the controller determines, as the amount of the parking fee, a higher amount in a case in which the observation data indicates that traffic congestion is occurring on the road at the second time point than in a case in which the observation data indicates that no traffic congestion is occurring on the road at the second time point.

4. The control apparatus according to claim 2, wherein the controller is configured to determine, as the amount of the parking fee, a higher amount as a degree of traffic congestion indicated by the ob servation data increases.

5. The control apparatus according to claim 1, wherein
the second time point is a later point in time than the first time point, and
the controller is configured to predict the traffic congestion condition at the second time point.

6. The control apparatus according to claim 5, wherein the controller determines, as the amount of the parking fee, a higher amount in a case in which traffic congestion is predicted to occur on the road at the second time point than in a case in which no traffic congestion is predicted to occur on the road at the second time point.

7. The control apparatus according to claim 5, wherein the controller is configured to determine, as the amount of the parking fee, a higher amount as a degree of predicted traffic congestion increases.

8. The control apparatus according to claim 1, wherein
the road has left-hand traffic, and
the controller is configured to adjust the amount of the parking fee depending on strength of a tendency for occurrence of traffic congestion on the road due to a left turn queue.

9. The control apparatus according to claim 8, wherein the controller is configured to add a higher amount to the amount of the parking fee as the strength of the tendency increases.

10. The control apparatus according to claim 1, wherein
the road has right-hand traffic, and
the controller is configured to adjust the amount of the parking fee depending on strength of a tendency for occurrence of traffic congestion on the road due to a right turn queue.

11. The control apparatus according to claim 10, wherein the controller is configured to add a higher amount to the amount of the parking fee as the strength of the tendency increases.

12. The control apparatus according to claim 1, wherein the controller is configured to adjust the amount of the parking fee depending on a lane count of the road.

13. The control apparatus according to claim 12, wherein the controller is configured to add a higher amount to the amount of the parking fee as the lane count decreases.

14. The control apparatus according to claim 1, wherein the controller is configured to execute charging processing for the parking fee with the determined amount.

15. A fee determination method comprising:
detecting, by a control apparatus, a vehicle parked on a road at a first time point; and
determining, by the control apparatus, an amount of a parking fee to be charged to the vehicle according to a traffic congestion condition on the road at a second time point that is same as or later than the first time point.

16. The fee determination method according to claim 15, wherein
the second time point is a same point in time as the first time point, and
the determining includes referring to observation data obtained by observing the traffic congestion condition at the second time point.

17. The fee determination method according to claim 15, wherein
the second time point is a later point in time than the first time point, and
the determining includes predicting the traffic congestion condition at the second time point.

18. The fee determination method according to claim 15, wherein
the road has left-hand traffic, and
the determining includes adjusting the amount of the parking fee depending on strength of a tendency for occurrence of traffic congestion on the road due to a left turn queue.

19. The fee determination method according to claim 15, wherein
the road has right-hand traffic, and
the determining includes adjusting the amount of the parking fee depending on strength of a tendency for occurrence of traffic congestion on the road due to a right turn queue.

20. The fee determination method according to claim 15, wherein
the determining includes adjusting the amount of the parking fee depending on a lane count of the road.
